(19) United States
(12) Patent Application Publication
(10) Pub. No.: US 2016/0187154 A1
(43) Pub. Date: Jun. 30, 2016

(54) PORTABLE ELECTRONIC DEVICE AND TRAVEL ASSISTING METHOD THEREOF

(71) Applicant: HON HAI PRECISION INDUSTRY CO., LTD., New Taipei (TW)

(72) Inventors: SHIANG-HUI WEI, New Taipei (TW); SHIH-FENG LU, New Taipei (TW); TAY-YANG LIN, New Taipei (TW)

(21) Appl. No.: 14/698,380

(22) Filed: Apr. 28, 2015

(30) Foreign Application Priority Data
Dec. 29, 2014 (TW) 103146153

(51) Int. Cl. G01C 21/36

(52) U.S. Cl. CPC G01C 21/3697

(57) ABSTRACT

A portable electronic device for assisting travelers includes a display, a traveling module, a lodging module, a navigating module, a food module, a cloud module, and a recording module. The traveling module can recommend a travelling schedule for one or more tourist attractions. The recommended schedule includes location information and a stay period for each tourist attraction. The location information includes information of each tourist attraction and a corresponding route to each of the one or more tourist attractions. The lodging module can prompt lodging information on the display. The navigating module can detect if the portable electronic device is proximate one of the plurality of tourist attractions. The food module can prompt food information on the display. The recoding module can record a moving trace of the portable electronic device. The cloud module can upload the moving trace.

### CROSS-REFERENCE TO RELATED APPLICATIONS

This application claims priority to Taiwanese Patent Application No. 103146153 filed on Dec. 29, 2014, the contents of which are incorporated by reference herein.

### FIELD

The subject matter herein generally relates to a portable electronic device and travel assisting method for the portable electronic device.

### BACKGROUND

When a person travels abroad, a guide may be needed for assistance. However, it is a waste of time to find a guide, or determine a tourist schedule in an unfamiliar place.

### BRIEF DESCRIPTION OF THE DRAWINGS

Implementations of the present technology will now be described, by way of example only, with reference to the attached figures.

FIG. 1 is a diagrammatic view of one embodiment of a portable electronic device.

FIG. 2 is a flowchart of one embodiment of a method for assisting travelers.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

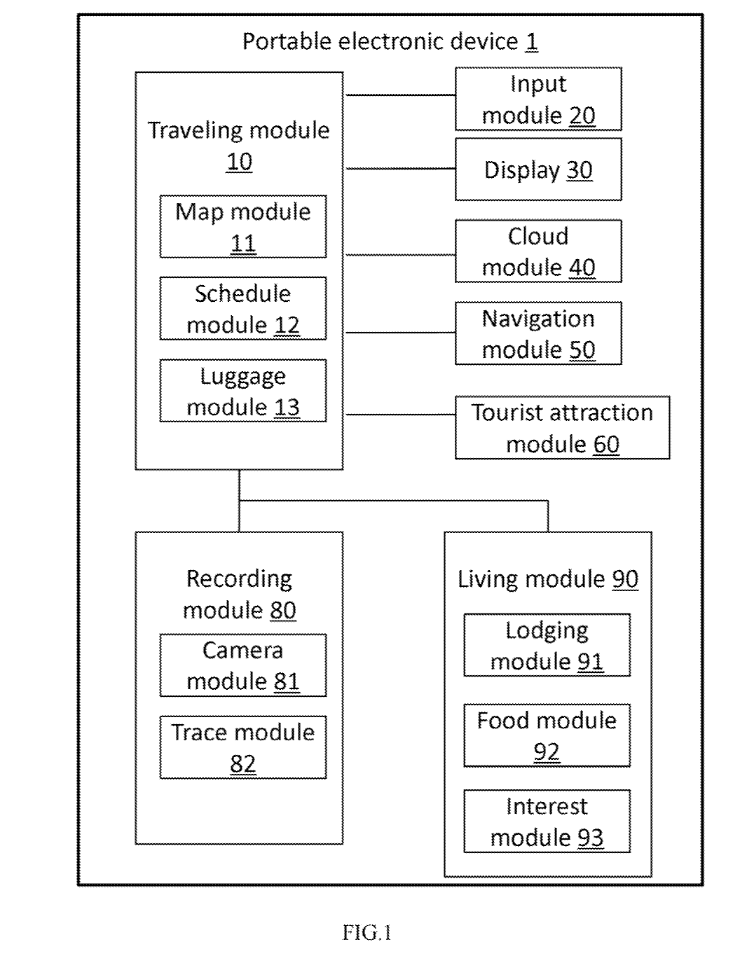

FIG. 1 illustrates a diagrammatic view of a portable electronic device of one embodiment. The electronic device 1 can be used to assist travelers, and can be a laptop computer, a tablet computer, a wearable device or a smart phone. It should be appreciated that the portable electronic device is only one example, and that the electronic device can have more or fewer components than shown, it can combine two or more components, or it can have a different configuration or arrangement of the components. The various components shown in FIG. 1 can be implemented in hardware, software or a combination of both hardware and software, including one or more signal processors and/or application-specific integrated circuits.

The electronic device 1 includes a traveling module 10. The traveling module 10 includes a map module 11, a schedule module 12, and a luggage module 13. The schedule module 12 can receive a plurality of travelling schedules from the Internet for a plurality of tourist attractions. Each travelling schedule can include a location of each tourist attraction, and a stay period for each tourist attraction. The location can include information of each tourist attraction and route. The plurality of travelling schedules can be ranked according to popularity. The map module 11 can generate an electronic map. Each travelling schedule can be presented on the electronic map. The luggage module 13 can be preset by the user to generate a luggage tracking list and send warning at a preset time.

The portable electronic device 1 can further include an input module 20 for providing user interface. The input module 20 can include a mouse or keyboard.

The portable electronic device 1 can further include a display 30. The display 30 can be a touch screen and can include a projector.

The portable electronic device 1 can further include a cloud module 40. The cloud module 40 can exchange local data in the portable electronic device with a cloud device, such as a server, or a work station through the Internet. The local data can include moving trace, lodging information and food information.

The portable electronic device 1 can further include a navigation module 50. The navigation module 50 can acquire a location of the portable electronic device 1 through a global positioning system (GPS), and can provide traveling navigation through the electronic map.

The portable electronic device 1 can further include a tourist attraction module 60. The tourist attraction module 60 can receive information of the plurality of tourist attractions through the cloud module 40. The information of the plurality of tourist attractions can include travel encyclopedia, an audio guide associated with each tourist attraction, and comments by other users.

The portable electronic device 1 can further include a living module 90. The living module 90 can include a lodging module 91, a food module 92, and an interest module 93. The lodging module 91 can prompt lodging information on the display 30 according to the route. The food module 92 can prompt food information when the portable electronic device is moved to be proximate one of the plurality of tourist attractions. The interest module 93 can prompt preset interest places, such as, shopping centers, banks, or car rentals.

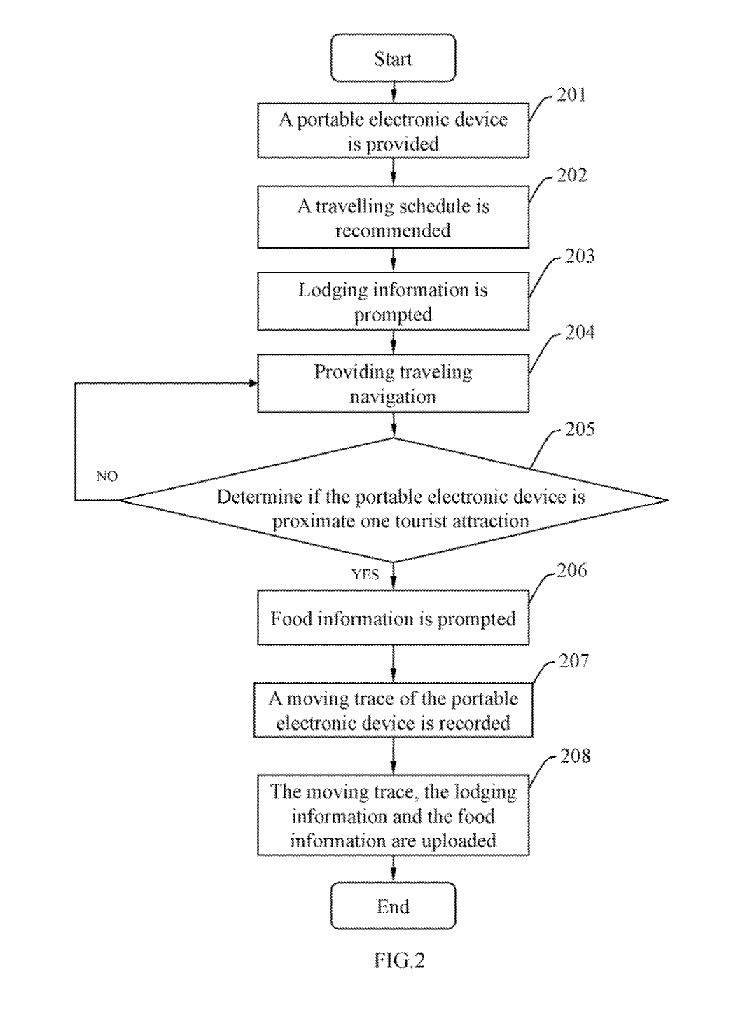

FIG. 2 illustrates a method for assisting travelers. The method can include the following blocks.

At block 201, a portable electronic device is provided.

At block 202, a travelling schedule for one or more tourist attractions is recommended. The travelling schedule can include location information of each tourist attraction and a stay period for each of the one or more tourist attraction, information of each tourist attraction, and a corresponding route to each of the one or more tourist attractions.

At block 203, lodging information is prompted on a display of the portable electronic device according to the route. The lodging information can be presented on an electronic map of the portable electronic device.

At block 204, a location of the portable electronic device is acquired and traveling navigation information is provided through the portable electronic device.

At block 205, determining if the portable electronic device is proximate one of the plurality of the tourist attractions; if yes, the blocks goes to block 206; if no, the blocks goes back to block 204.

At block 206, food information is prompted on the display when the portable electronic device is proximate the one or more tourist attractions.

At block 207, a moving trace of the portable electronic device is recorded.

At block 208, the moving trace, the lodging information and the food information are uploaded from the portable electronic device through the cloud module, and the moving trace, the lodging information and the food information are associated with a time and location.

The embodiments shown and described above are only examples. Many details are often found in the art such as the other features of a travel assisting method and a portable electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A travel assisting method for travelers comprising:
recommending a travelling schedule for one or more tourist attractions, wherein the travelling schedule comprises location information and a stay period for each of the one or more tourist attractions, the location information including information for each of the one or more tourist attractions and a corresponding route to each of the one or more tourist attractions;
prompting lodging information on a display of the portable electronic device according to the corresponding route to the one of the one or more tourist attractions;
detecting if a portable electronic device is proximate one of the one or more tourist attractions;
prompting food information on the display when the portable electronic device is proximate the one of the one or more tourist attractions;
recording a moving trace of the portable electronic device; and
uploading the moving trace from the portable electronic device and associating the moving trace with a time.

2. The method of claim 1, wherein the travelling schedule is generated from a remote device through internet.

3. The method of claim 1, further comprising acquiring a location of the portable electronic device, and providing traveling navigation through the portable electronic device.

4. The method of claim 3, wherein the location of the portable electronic device is acquired through a global positioning system.

5. The method of claim 1, further comprising uploading the lodging information and the food information from the portable electronic device and associating the lodging information and the food information with time and location.

6. The method of claim 1, further generating a luggage tracking list, and alerting at preset time.

7. The method of claim 1, wherein the travelling schedule is ranked according to popularity.

8. A portable electronic device for assisting travelers comprising:
a display;
a traveling module configured to recommend a travelling schedule for one or more tourist attractions, wherein the travelling schedule comprises location information and a stay period for each of the one or more tourist attractions, the location information including information for each of the one or more tourist attractions and a corresponding route to each of the one or more tourist attractions;
a lodging module configured to prompt lodging information on a display of the portable electronic device according to the corresponding route to the one of the one or more tourist attractions;
a navigating module configured to detect if the portable electronic device proximate one of the plurality of tourist attractions;
a food module configured to prompt food information on the display when the portable electronic device is proximate the one of the one or more tourist attractions;
a recoding module configured to record a moving trace of the portable electronic device; and
a cloud module configured to upload the moving trace from the portable electronic device and associating the moving trace with a time.

9. The portable electronic device of claim 8, wherein the travelling schedule is generated from a remote device through internet.

10. The portable electronic device of claim 8, wherein the navigation module is further configured to acquire a location of the portable electronic device, and provide traveling navigation through the portable electronic device.

11. The portable electronic device of claim 10, wherein the location of the portable electronic device is acquired through a global positioning system.

12. The portable electronic device of claim 8, wherein the cloud module is further configured to upload the lodging information and the food information from the portable electronic device and associate the lodging information and the food information with time and location.

13. The portable electronic device of claim 8, further comprising a luggage module configured to generate a tracking list and alert at preset time.

14. The portable electronic device of claim 8, wherein the travelling schedule is ranked according to popularity.
